(19) United States
(12) Patent Application Publication
(10) Pub. No.: US 2026/0295875 A1
(43) Pub. Date: Oct. 1, 2026

(54) BLADE CLIPPER GUARD COMB ATTACHMENT DEVICE

(71) Applicant: AMY LEIGH SCHOUTEN, MYERSTOWN, PA (US)

(72) Inventor: AMY LEIGH SCHOUTEN, MYERSTOWN, PA (US)

(21) Appl. No.: 19/339,729

(22) Filed: Sep. 25, 2025

Related U.S. Application Data
(60) Provisional application No. 63/779,574, filed on Mar. 28, 2025.

(51) Int. Cl. B26B 19/20; B26B 19/38

(52) U.S. Cl. CPC B26B 19/20; B26B 19/3813

(57) ABSTRACT

This application relates generally to a novel guard comb attachment for hair clipper devices comprising an increased plurality of variably spaced teeth, wherein such teeth may include shorter, secondary teeth. This improved design allows for better outcomes over traditionally available guard combs, which typically contain 8-12 uniformly spaced teeth, as the novel comb's variable spacing, increased tooth count, and “skip-tooth” design all provide for deeper penetration into hair or fur, more level control, and enhanced feed efficiency into the clipper blades resulting in a smoother, more even cut in less passes and with less effort compared to standard guard combs having fewer and uniformly spaced teeth. Additional features of the novel guard comb include an improved clipper attachment means and a self-leveling comb.

### CROSS-REFERENCE TO RELATED APPLICATIONS

This patent application claims the benefit of and priority to U.S. Provisional Patent Application Ser. No. 63/779,574 filed Mar. 28, 2025 entitled, “BLADE CLIPPER GUARD COMB ATTACHMENT DEVICE,” which is incorporated herein in its entirety.

### BACKGROUND OF THE INVENTION

This invention relates generally to hair clipper guard combs for animals and humans and in particular to an improved guard comb design allowing users of hair clippers better outcomes over traditional and currently available designs.

Hair clippers are commonly used to cut and trim hair. Hair clippers contain a cutting element comprised of two blades with teeth which slide back and forth at a high speed to quickly snip large quantities of hair that are fed into the cutting element. Hair clippers are used for both human hair and animal hair. Hair clippers for animal hair may be designed and manufactured to be larger and/or more durable. Common users of hair clippers are pet groomers, who routinely use the devices in their daily work to cut, trim, style, maintain, and clean the coats of their clients'pets.

A guard comb attachment is made for both animal clippers and human clippers. Guard combs are removable plastic or metal guides that attach over the clippers blade. They are designed to help maintain a consistent cutting length while grooming an animal's fur or human hair. Guard comb attachments made to fit on human clippers are design differently than guard comb attachments made to fit on animal clippers. Guard combs come in various sizes, each corresponding to a specific cutting length. Common sizes range from ⅛-inch to 1 ½-inch scaling in ⅛-inch increments.

Guard combs provide many advantages to hair stylists and pet groomers. Available in different sizes, they help maintain a consistent cut length without needing advanced scissoring skills. Unlike using a clipper blade alone, guard combs create a safe buffer between the blade and the skin, reducing the risk of cutting too close or causing skin irritation. Guard combs prevent the fur or hair from being clipped too short, which can lead to uneven patches or skin exposure. They are particularly useful for fluffy or thick-coated dog breeds like Poodles, Doodles, and Bichons, helping create a plush, natural look. They help in blending transitions between shorter and longer areas, making styling smoother.

Guard combs speed up the grooming process by allowing groomers to quickly trim without excessive scissoring. Less scissoring means less strain on the groomer's hands and a more comfortable experience for the animal. Compared to a straight blade cut, guard combs leave the hair with a softer finish, which achieves a more natural and fluffy appearance. They are commonly used for pet trims, where a rounded and blended look is preferred.

By using guard combs, beginner groomers can achieve a polished look without mastering advanced scissoring techniques right away. Experienced groomers can use guard combs to efficiently rough in lengths before fine-tuning details with scissors.

Despite the ubiquity of hair clippers and guard combs in the beauty and grooming industries, there are many common issues caused by their current design. Even when using a guard comb, achieving perfectly even cuts can be challenging. Factors such as varying hair density and coat texture can lead to inconsistencies in the cut length.

Secure attachment of the guard comb to the hair clipper device is also an issue. If the guard comb is not constructed from strong material or designed to securely attached to the clipper blade, it may slip or detach during grooming. This can result in uneven cuts or accidental clipping of the fur shorter than intended.

Current combs also fail to produce a precise and smooth finish. Due to the space between the teeth on guard combs, often the hair feeding into the clipper blade cutting edge will fall away instead of directly into the clipping area of the clipper blade. This causes the user to stop clipping, comb the hair up again, and make several passes with the clippers to achieve a precise and smooth appearance. Depending on the subject's hair density, a smooth finish may not be possible. This happens when using guard combs on thin or limp dog fur and human hair as well.

Hair packing is another common issue. Hair packing in clipper blades and guard comb attachments refers to the accumulation of hair, debris, or oil between the teeth. Hair packing can cause the clipper blades to become less effective, resulting in uneven cutting, pulling on the hair, or overheating the blades. Hair packing requires the operator to stop clipping and manually free the hair clippings and debris from the clipper blade and guard comb attachment.

Professional pet groomers and beauticians strive to achieve professional-quality grooming and trimming results. When guard combs fail to accomplish a precise/smooth finish, it forces groomers and beauticians to resolve the issue by hand scissoring. The task of hand scissoring the finish adds time to the session and requires a seasoned skill level.

What is needed is an improved guard comb that can produce a more even, precise, and smooth finish with less hair packing, snagging, pulling and error in less passes and with greater ease for the hair clipper user.

### SUMMARY OF THE INVENTION

Some embodiments of the presently claimed invention provide a guard comb attachment for a hair clipper apparatus comprising a molded clip housing with means for attachment to a detachable blade clipper device, said molded clip housing having a plurality of teeth extending distally away from the attachment means, wherein said teeth are arranged in a variable spacing pattern.

In certain embodiments of the invention, said teeth of the guard comb comprise primary teeth and secondary teeth, or “skip-teeth,” which extend distally away from the attachment means at a shorter distance than the primary teeth, which extend distally away from the attachment means at a longer distance than the secondary teeth. Said primary teeth and secondary teeth may be placed and joined by the comb housing in an alternating pattern. Alternatively, said secondary teeth may be placed within the primary teeth at intervals ideal for the desired outcome.

The variable spacing pattern of the claimed guard comb teeth allows for enhanced coat feed, a smoother cut, reduced snagging, and better trim control by the user, providing for less overall trimming passes by the user and a reduced overall grooming time.

The variable spacing pattern of the claimed guard comb refers to varying interstitial space between the teeth of the guard comb, whether primary or secondary, or whether uniform, alternating, or varying in distal length.

Such variable spacing patterns may include predetermined intervals wherein a secondary tooth is placed every second, third, or fourth primary tooth, or such other fixed spacing patterns of teeth selected to optimize coat feed and reduce resistance while the device is in use. Such intervals may be uniformly spaced or of varied, non-uniform spacing.

Further, some embodiments of the inventions may include varying tooth length beyond uniform primary and uniform secondary teeth (i.e. tertiary, quaternary, etc.).

Further, the attachment means provides a more secure fit when attached to a clipper blade, reducing slippage and leading to overall improved use.

In all embodiments, the claimed guard comb is characterized by an increased number of teeth compared to existing standard models. This increased tooth count is fundamental to the invention and is designed to prevent hair from falling away from the teeth during grooming. By enabling more consistent contact with the coat, the additional teeth reduce the number of passes required with clippers, improving grooming speed and finish quality. This design distributes pressure more evenly, which minimizes resistance, reduces discomfort, and makes the grooming process less stressful—particularly in sensitive areas such as the face, legs, and sanitary zones.

In some embodiments, the claimed guard comb comprises an increased number of teeth over standard models, which prevents hair passing through the comb from falling away from the teeth and minimizes the need for multiple passes with the hair clippers. More teeth help distribute the pressure evenly across the hair, reducing resistance and discomfort for the subject. This specifically makes pet grooming less stressful, especially for sensitive areas like the face, legs, or sanitary trims.

The additional teeth also create a finer finish, making it easier to blend different coat lengths seamlessly, which achieves a more natural, professional look with fewer scissor corrections. There is less need for re-trimming or going over the same area multiple times, saving time during the grooming process. It also reduces strain on the groomer's hands by shortening the time needed to complete the overall trim while producing smooth, professional results. This reduces the need for manual scissor blending to complete a groom, thereby improving overall workflow for professional groomers.

The increased teeth and variable spacing design also reduce hair packing at the cutting edge of the clipper blade by lifting and pushing more hair away. The increased number of teeth and variable spacing in the guard comb work together to optimize hair flow and distribution, effectively preventing excessive accumulation at the cutting edge of the clipper blade. The variable spacing between the teeth allows hair strands to be lifted in stages, ensuring a gradual elevation that pre-aligns the hair before reaching the blade. This prevents dense clusters from forming at a single point, which is a common issue with traditional guard combs. Unlike conventional designs that create a bottleneck effect by forcing hair into the blade in an unstructured manner, the presently disclosed design regulates hair displacement by directing it through multiple pathways, ensuring a steady and even feed into the cutting edge.

The presence of secondary teeth in some embodiments further enhances the hair flow and feed process by creating additional entry points for hair, preventing it from bunching up at the base of the guard comb. These secondary teeth, or “skip-teeth,” strategically positioned between and slightly offset from the primary teeth, redistribute excess hair evenly across the blade's width, reducing jams or clogs and ensuring a more consistent hair intake. Additionally, the extended structure of the secondary teeth functions as a hair-pushing mechanism, continuously nudging excess hair outward instead of allowing it to compact at the blade's cutting edge. By minimizing hair buildup and friction, the design allows the blade to maintain optimal speed and efficiency while reducing strain on the clipper motor, preventing overheating, and extending the longevity of both the blade and motor. Ultimately, the presently disclosed guard comb attachment ensures a smooth, unobstructed hair flow that eliminates packing, enhances cutting precision, and significantly improves overall grooming efficiency.

The “skip-tooth” design of the guard comb reduces the resistance often encountered when a user is entering a coat or patch of hair at the start of a clipper pass, particularly where the hair is longer and/or denser. The “skip-teeth” allow the comb to penetrate the hair or fur deeper and more efficiently so that the clipper pass is smoother and more controlled by strategically spacing the teeth to create wider entry gaps while maintaining overall structural integrity. Unlike traditional guard combs with evenly spaced teeth that can create a surface barrier, the alternating pattern of “skip-teeth” reduces resistance by allowing hair and coat density to be distributed more effectively. The gaps between the teeth provide clearer entry points, enabling the comb to bypass surface tension and reach deeper layers of the coat without excessive force. This is particularly beneficial for thick, dense, or curly coats where standard combs tend to ride over the outer layer rather than separating and guiding hair efficiently into the cutting blade. Additionally, the increased spacing between the primary teeth reduces drag, minimizing resistance as the comb moves through the coat.

Guard combs with more teeth and closer spacing provide enhanced adaptability for trimming various hair and coat types. They allow for finer length adjustments, making them ideal for a broader range of animal grooming tasks and human hair trimming techniques. Currently, the required features of dog clipper guard comb attachments are to accomplish uniform, overall fur or hair length when trimming dog fur or human hair.

Some embodiments of the inventions may be adapted for both detachable blade clippers and adjustable blade clippers. In some embodiments, the guard combs are adapted to be compatible with any A or A5 series clipper blade. In some embodiments, the guard combs are available in the sizes: 3, 6, 10, 13, 16, 19, 25, or 32 mm (and their corresponding imperial measurements). Some embodiments of the invention may be adaptable to alternative clipper blade apparatuses and available in sizes smaller, larger, and intermediate to the foregoing.

In some embodiments, the invention is constructed from rigid plastic, metal, and stainless-steel materials for durability. It may feature a friction-reducing coating or anti-static treatment for smoother operation. It may additionally include reinforced rigid plastic securing the stainless-steel teeth to prevent breakage and extend the lifespan of the device.

In some embodiments, the invention features a snap-locking system wherein the guard comb has a rigid plastic base structure and integrated spring-loaded tensioned clips at the sides and rear. When combined with a blade clipper device, the spring-loaded tensioned clips of the plastic base structure stretch to hook into place over the clipper spine and housing then snap to lock into place when the spring tension is activated.

In some embodiments, the invention features a further securing means whereby the teeth include at their base downward facing indentations, which when combined across all teeth form a guide rail that is able to clip over the cutting blade of a blade clipper device and improve overall pressure distribution across the guard comb attachment device. Alone or in combination with the snap-locking feature, the guide rail feature provides self-leveling of the guard comb attachment device for improved outcomes.

In some embodiments of the invention, a guard comb having 15 teeth may be preferred for use on dense coat types (e.g. Poodles, Bichon Frises), although other counts may be preferred or desirable based on hair type, subject, and other factors.

In some embodiments of the invention, a guard comb having 16 teeth may be preferred for use on silky coat types (e.g. Yorkies, Maltese, Shih Tzus), although other counts may be preferred or desirable based on hair type, subject, and other factors.

All embodiments of the invention will include a plurality of teeth and at least one additional tooth beyond what is currently available.

In some embodiments of the invention, the tooth spacing is customizable to any variable or uniform distance between teeth to achieve the desired spacing for the desired level of control and finish.

The presently disclosed invention is in strict contrast with and improves upon known standard guard combs that typically utilize 8-12 teeth that are uniformly spaced and of equal distal length. The increased number of teeth, variable spacing, and inclusion of varied distal tooth length all contribute to increased performance of the device while in use and a more desirable finish.

### BRIEF DESCRIPTION OF DRAWINGS

FIG. 1 is a frontside of an embodiment of the invention comprising a guard comb attached to a hair clipper device.

FIG. 2 is an underside view of an embodiment of the invention.

FIG. 3 is an upward angled frontside view of an embodiment of the invention.

FIG. 4 is a downward angled frontside view of an embodiment of the invention.

FIG. 5 is an alternative frontside view of an embodiment of the invention.

FIG. 6 is an alternative underside view of an embodiment of the invention.

FIG. 7 is a side angle underside view of an embodiment of the invention.

FIG. 8 is a side angle top view of an embodiment of the invention attached to an adjustable blade clipper device.

FIG. 9 is an alternative underside view of an embodiment of the invention.

FIG. 10 is a side angle top view of an embodiment of the invention.

FIG. 11 is a side view of an embodiment of the invention depicting its method of attachment to a blade clipper device.

FIG. 12 is a side view of an embodiment of the invention depicting its method of detachment from a blade clipper device.

FIG. 13 is an underside view of an embodiment of the invention having primary and secondary teeth.

FIG. 14 is a side angle underside view of an embodiment of the invention having primary and secondary teeth.

FIG. 15 is a side angle topside view of an embodiment of the invention having primary and secondary teeth.

FIG. 16 is a flowchart depicting a method of grooming hair using an embodiment of the invention.

### DETAILED DESCRIPTION OF THE INVENTION

It should be understood that this application is not limited to the details or methodology set forth in the following descriptions or illustrated in the figures. It should also be understood that the phraseology and terminology employed herein is for the purpose of description only and should not be regarded as limiting.

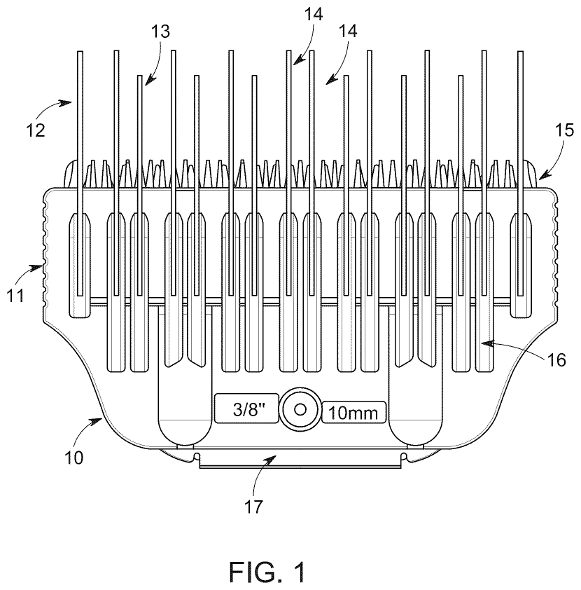

As shown in FIG. 1, at least one preferred embodiment of the presently claimed invention is a guard comb attachment for a hair clipper device comprising a molded housing 10 having grips 11 on its sides, wherein the housing 10 is molded to receive and secure via receptacles 16 a plurality of teeth 12, 13, wherein the teeth have variable spacing 14, wherein the teeth are a combination of primary teeth 12 and secondary teeth 13, wherein the primary teeth 12 extend distally from the housing 10 farther than the secondary teeth 13 and the secondary teeth 13 extend distally from the housing 10 nearer than the primary teeth 12, such teeth providing a desired amount of spacing from clipper blades 15, and wherein the guard comb attachment is attached to the hair clipper device via attachment means 17.

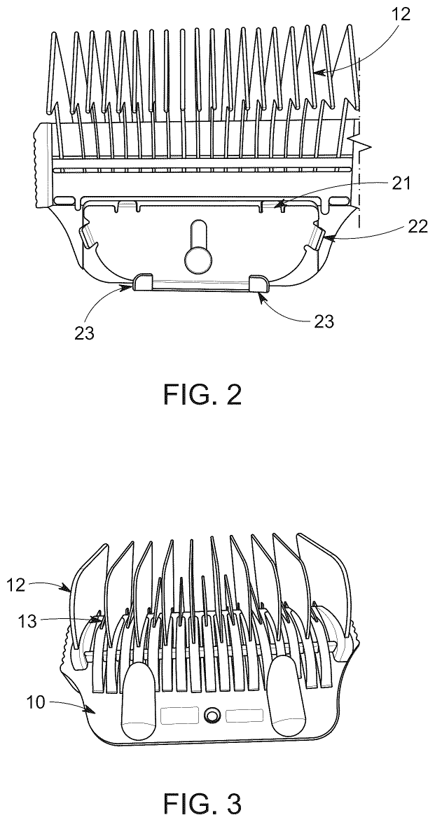

As shown in FIG. 2, at least one preferred embodiment of the presently claimed invention further comprises the attachment means 17 of FIG. 1 having rear clips 23, front clips 21, and side clips 22. In some embodiments, the clips are spring-loaded for easy and secure attachment to a blade clipper device, as well as easy removal from a blade clipper device.

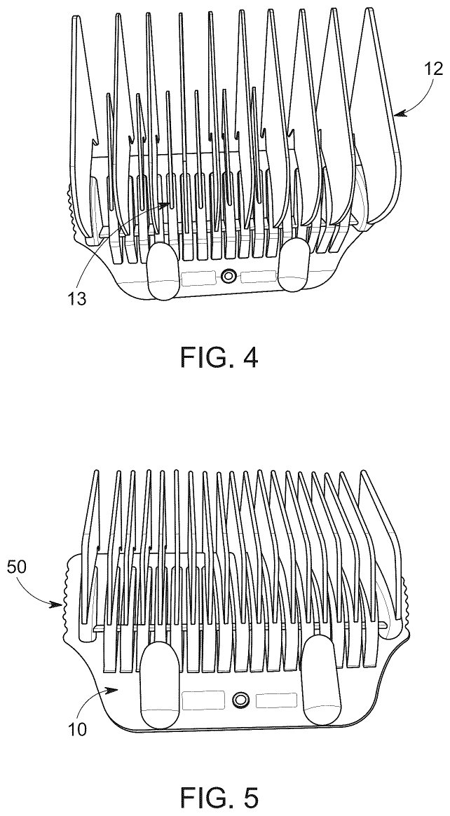

The primary teeth 12 and secondary teeth 13 attached to housing 10 can be seen in more detail from an upward angle in FIG. 3 and from a downward angle in FIG. 4.

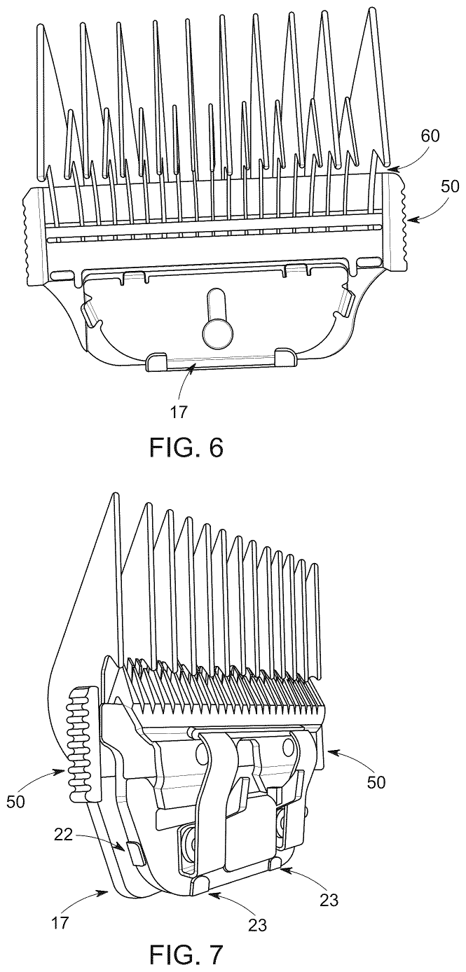

FIG. 5 depicts an embodiment of the invention having side grips 50 molded into guard comb housing 10 which additionally act as tension blade clips.

As shown in FIG. 6, an embodiment of the invention having downward facing indentations in the teeth 60, which combined act as a guard rail and a secondary securing means for the guard comb to the blade clipper device. Guard rail (comprising the plurality of indentations) 60 further provides the device with self-leveling when properly attached to a blade clipper device.

FIG. 7 shows an embodiment of the invention from an alternative angle and comprises side grips 50, rear clips 23, and side clips 22 comprising attachment means 17.

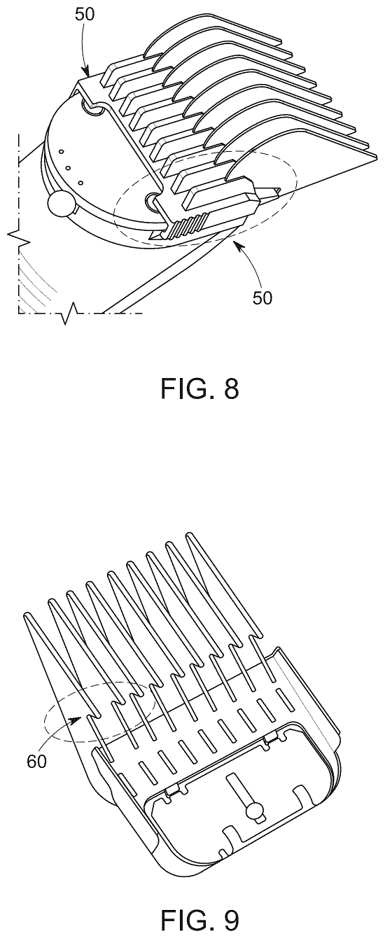

FIG. 8 shows an embodiment of the invention adapted for an adjustable blade clipper device having side grips 50, which contain the side clips and guard rail as the main attachment and securement means.

FIG. 9 is an alternative depiction of an embodiment of the invention showing guard rail 60 from the underside, and FIG. 10 is an alternative depiction of an embodiment of the invention showing guard rail 60 from the frontside.

As shown in FIG. 11, the guard comb attachment device is attached to a blade clipper device 101 by attachment means 17, as detailed further in the other figures, by a forward and upward force motion.

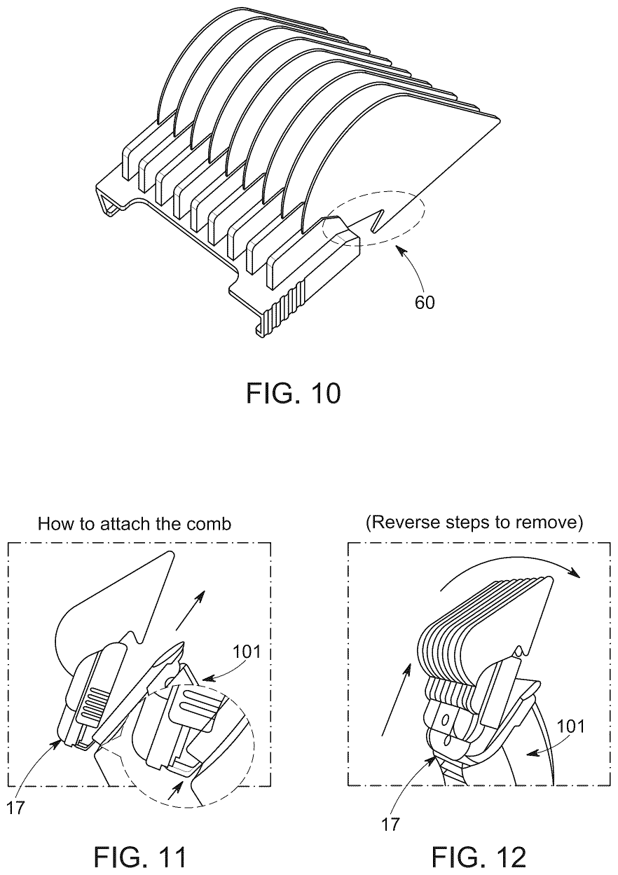

As shown in FIG. 12, the guard comb attachment device is detached from a blade clipper device 101 by attachment means 17, as detailed further in the other figures, by a forward and downward force motion.

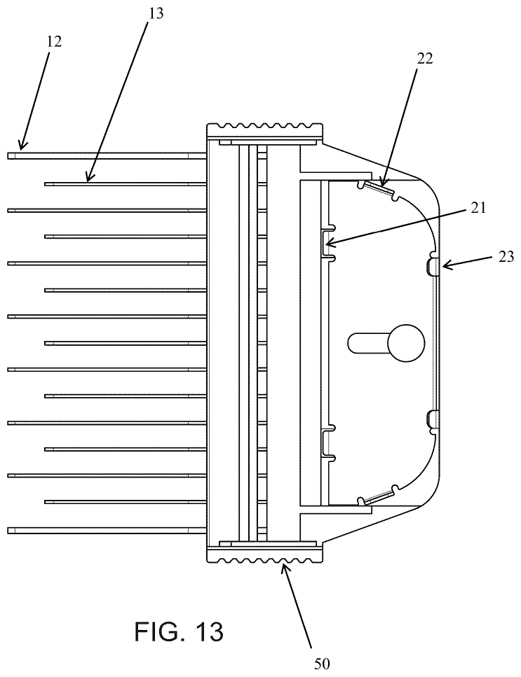

As shown in FIG. 13, an embodiment of the guard comb device having primary teeth 12 and secondary teeth 13 may be attached or detached to or from a blade clipper device by an attachment means comprising front clips 21, side clips 22, and rear clips 23, while being gripped with side grips 50.

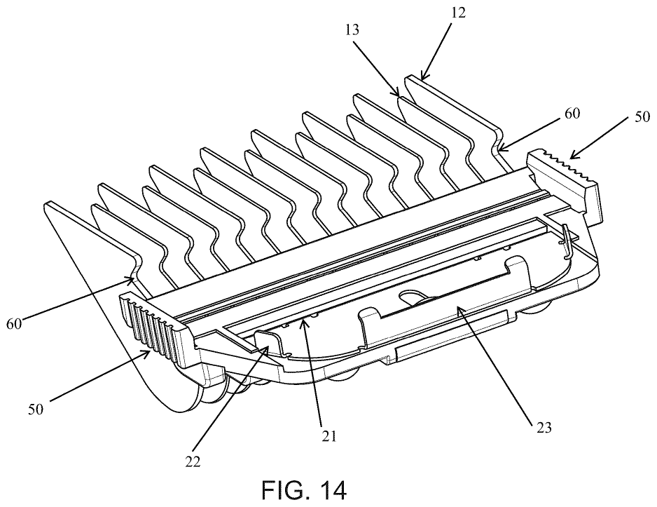

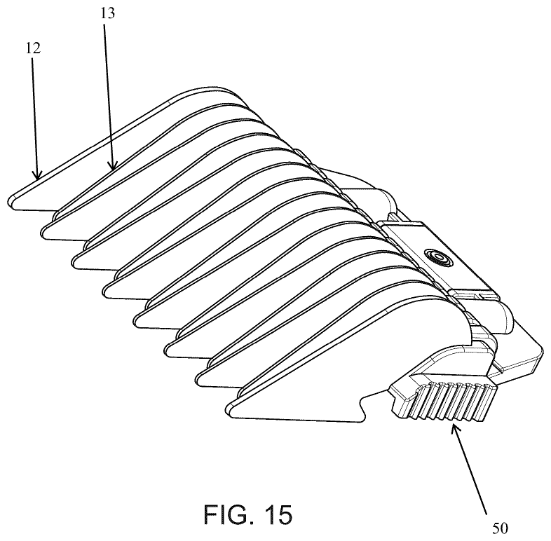

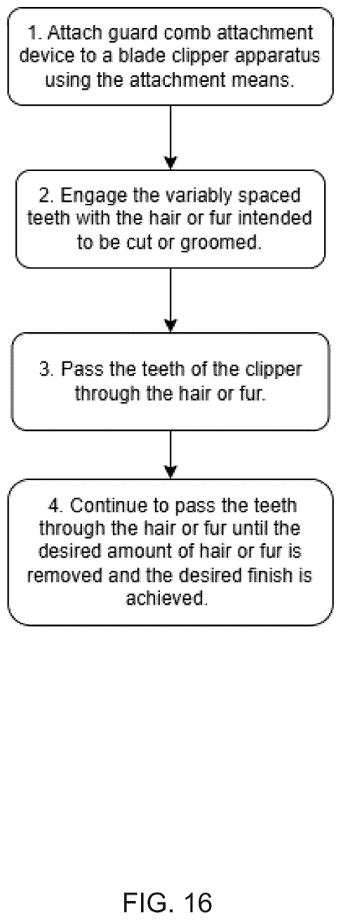

As shown in FIG. 14, an embodiment of the guard comb device having an attachment means comprising front clips 21, side clips 22, and rear clips 23, further comprising side grips 50, also comprises a guard rail 60 formed by indentations in the primary teeth 12 and secondary teeth 13.

As shown in FIG. 15, an embodiment of the guard comb device comprises primary teeth 12 and secondary teeth 13, and may be gripped and attached via side grips 50.

In at least one embodiment of the invention, the plurality of teeth comprises at least 15 teeth.

In at least one embodiment of the invention, the plurality of teeth comprises at least 16 teeth.

In some embodiments of the invention, the guard comb attachment is adapted to fit any A or A5 series hair clipper device.

In some embodiments of the invention, the guard comb attachment is available in the sizes: 3, 6, 10, 13, 16, 19, 25, or 32 mm (and their corresponding imperial measurements).

Some embodiments of the invention may be adaptable to alternative clipper blade apparatuses and available in sizes smaller, larger, and intermediate to the foregoing.

In some embodiments of the invention, the guard comb attachment is adapted for detachable blade clippers.

In some embodiments of the invention, the guard comb attachment is adapted for adjustable blade clippers. Such adaptation has an attachment means primarily attached to the blade clipper device via side clips, front clips, and a front guide rail aligned with the clipper blade.

The presently claimed invention may be constructed of any material and manufactured by any means, including without limitation rigid plastic, metal, and stainless-steel materials for durability, and via stereolithography, 3D printing, and other additive and subtractive methods of manufacture.

Preferred embodiments of the invention will feature teeth made of stainless steel.

In some embodiments of the invention, the number of both primary and secondary teeth and the variable spacing of the teeth may be customizable for the preferred outcomes and nothing herein shall limit the possible combinations of the same that are claimed herein.

While the present invention has been illustrated by description of several embodiments and while the illustrative embodiments have been described in considerable detail, it is not the intention of the applicant to restrict or in any way limit the scope of the append-ed claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Moreover, in the description above, for the purposes of explanation, numerous specific de-tails have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the detailed description are hereby expressly incorporated into this detailed description, with each claim standing on its own as a separate embodiment of the invention.

I claim all subject matter disclosed herein.

What is claimed is:

1. A guard comb attachment device for a hair clipper apparatus comprising:
a molded housing having attachment means for removably securing the guard comb attachment device to a hair clipper apparatus;
a plurality of teeth extending distally away from said housing, wherein said plurality of teeth comprises at least one (1) additional tooth relative to standard guard combs of equivalent size;
wherein said teeth are arranged with variable spacing between adjacent teeth; and
wherein said variable spacing is configured to enhance hair flow, reduce hair packing, and improve cutting control.

2. The guard comb attachment device of claim 1, wherein said plurality of teeth comprises at least fifteen (15) teeth.

3. The guard comb attachment device of claim 1, wherein said plurality of teeth further comprises:
primary teeth extending to a first distal distance from the housing; and
secondary teeth extending to a second distal distance from the housing, wherein said second distal distance is shorter than said first distal distance.

4. The guard comb attachment device of claim 3, wherein said primary teeth and secondary teeth are arranged in an alternating pattern.

5. The guard comb attachment device of claim 3, wherein said secondary teeth are positioned at predetermined intervals between said primary teeth to optimize hair flow and reduce resistance during initial coat penetration.

6. The guard comb attachment device of claim 1, wherein the attachment means comprises:
at least one rear clip; a least one front clip; and at least two side clips integrated into the side grips of the housing.

7. The guard comb attachment device of claim 6, wherein one or more clips are spring loaded.

8. The guard comb attachment device of claim 1, further comprising a guide rail formed by downward facing indentations at the base of said teeth, wherein said guide rail is configured to clip over a cutting blade of the hair clipper apparatus.

9. The guard comb attachment device of claim 1, wherein the teeth are constructed of stainless steel.

10. The guard comb attachment device of claim 1, wherein the device is configured to be compatible with an A-series or A-5 series clipper blade.

11. The guard comb attachment device of claim 1, wherein the device is configured in sizes selected from the group consisting of: 3 mm, 6 mm, 10 mm, 13 mm, 16 mm, 19 mm, 25 mm, and 32 mm.

12. The guard comb attachment device of claim 1, wherein the device is configured to be compatible with an adjustable blade clipper apparatus, and wherein said attachment means primarily comprises side clips and a front guide rail formed by downward facing indentations at the base of said teeth and is aligned with the blade of the clipper apparatus.

13. A guard comb attachment device for a hair clipper apparatus comprising:
a molded housing having attachment means for securing to the hair clipper apparatus;
a plurality of primary teeth extending distally away from said housing to a first distance;
a plurality of secondary teeth extending distally away from said housing to a second distance, wherein said second distance is shorter than said first distance;
wherein said primary and secondary teeth are arranged in a variable spacing pattern.

14. The guard comb attachment device of claim 13, further comprising a plurality of tertiary or tertiary and quaternary teeth, wherein the tertiary and quaternary teeth extend away from said housing distally to distances varied from the primary and secondary teeth.

15. The guard comb attachment device of claim 13, further comprising:
a guide rail formed from downward facing indentations at the base of each tooth, wherein the indentations collectively engage with a cutting blade of the hair clipper apparatus; and
wherein said guide rail provides self-leveling of the guard comb attachment device when attached to the hair clipper apparatus.

16. The guard comb attachment device of claim 13, wherein the plurality of primary teeth and secondary teeth comprises at least fifteen (15) teeth.

17. The guard comb attachment device of claim 13, wherein the molded housing has a friction reducing coating or anti-static treatment for smoother operation and durability.

18. The guard comb attachment device of claim 13, wherein the attachment means comprises a plurality of clips positioned on the rear, front, and side of the device; and wherein one or more of the clips are spring loaded.

19. The guard comb attachment of claim 17, wherein said clips are attached to the proximal end of the device and stretched to engage the hair clipper apparatus, then recede and lock into place when spring tension in the spring loaded clips is activated.

20. The guard comb attachment device of claim 13, wherein the device is configured to fit any A-series or A-5 series clipper apparatus and is configured in a size selected from the group consisting of: 3 mm, 6 mm, 10 mm, 13 mm, 16 mm, 19 mm, 25 mm, and 32 mm.

21. The guard comb attachment device of claim 13, wherein the device is configured to be compatible with an adjustable blade clipper apparatus.

22. A method of grooming hair using the guard comb attachment device of claim 1, comprising:
attaching the guard comb attachment device a blade clipper apparatus using the attachment means;
engaging the variably spaced teeth with hair to be cut;
passing said teeth and said blade clipper through said hair until the desired amount of hair is cut;
wherein the variable spacing and plurality of the teeth reduces the number of passes required to achieve a smooth finish and decreases hair packing and snagging during the cutting process.

23. The method of grooming hair of claim 22, wherein the variable spacing and plurality of teeth reduces the number of passes required to achieve a smooth finish by at least twenty percent (20%) compared to a standard guard comb containing fewer, uniformly spaced teeth.
